(19) United States
(12) Patent Application Publication
(10) Pub. No.: US 2025/0094196 A1
(43) Pub. Date: Mar. 20, 2025

(54) MANAGING SESSION LIFECYCLES THROUGH CUSTOM SCRIPTS IN A NETWORK-SEGREGATED ENVIRONMENT

(71) Applicant: Oracle International Corporation, Redwood Shores, CA (US)

(72) Inventors: Rohit Garg, Bothell, WA (US); Heather Marie Huggins, Thousand Oaks, CA (US); Jonathan Paul Beaulac-Korntved, Eugene, OR (US)

(21) Appl. No.: 18/436,985

(22) Filed: Feb. 8, 2024

Related U.S. Application Data
(60) Provisional application No. 63/538,674, filed on Sep. 15, 2023.

(51) Int. Cl. G06F 9/455

(52) U.S. Cl. CPC G06F 9/45558; G06F 2009/45595

(57) ABSTRACT

Techniques for managing session lifecycles through custom scripts in a network environment are provided. In one technique, a container of a virtual machine receives a termination signal that is associated with a command to delete or deactivate a session of the container. In response and prior to terminating the session, the container identifies and executes a script that is associated with the command. After the script completes executing, the session is deleted or deactivated. In another technique, cloud system receives reference data that identifies a storage location of a script. A virtual machine is created in the cloud system. Based on the reference data, the script is downloaded from the storage location into storage that is local to the virtual machine. The script is executed and a session within a container of the virtual machine is initiated.

### TECHNICAL FIELD

The present disclosure relates generally to cloud session management and, more particularly, to processing custom scripts at different stages of a cloud session lifecycle.

### BACKGROUND

An integrated development environment (IDE) is a software application that provides comprehensive facilities for software development. Jupyter is an IDE for creating “live” documents, known as “Jupyter Notebooks,” that include code, equations, visualizations, and text. Jupyter is tailored to machine learning engineers and data scientists. Thus, some uses of Jupyter Notebooks include data exploration, prototyping machine learning models, and sharing findings with colleagues. The name “Jupyter” comes from the core programming languages that it supports: Julia, Python, and R.

There are several major pain points for cloud users who desire to leverage Jupyter Notebooks when setting up and tearing down their respective Notebook sessions in a cloud environment. The manual effort involved in recreating a Notebook environment every time a new Notebook session is created, and cleaning up existing Notebooks before a Notebook session is terminated leads to inefficiencies, errors, and concerns about data persistence from more security-aware customers. This problem is further exacerbated by forced deactivation of Notebook sessions as part of a cloud service's regular security patching, which currently leaves customers with no opportunity to clean up their Notebooks in an automated manner before the sessions are deactivated. The current state of affairs is cumbersome for existing cloud users and a barrier for adoption by prospective customers.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 is a block diagram that depicts an example system for executing life cycle scripts, in an embodiment;

FIG. 2 is a block diagram that depicts an example system for processing a delete or deactivate workflow, in an embodiment;

FIG. 3 is a block diagram that depicts an example container within a virtual machine, in an embodiment;

FIG. 4 is a flow diagram that depicts an example process for deleting or deactivating a session of a container in a cloud system, in an embodiment;

FIG. 5 is a flow diagram that depicts an example process for starting a session, in an embodiment;

FIG. 6 is a block diagram that illustrates a computer system upon which an embodiment of the invention may be implemented;

FIG. 7 is a block diagram of a basic software system that may be employed for controlling the operation of the computer system.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### Containers and Session Control

Some cloud providers include cloud services that provide managed sessions. JupyterLab sessions are referred to as “Notebook sessions.” These sessions are hosted on service-owned virtual machines (VMs) that run a pre-configured container image maintained by the cloud provider.

A container image is a lightweight, standalone, executable package of software that includes everything needed to run an application, such as code, runtime, system tools, system libraries, and settings. Containers facilitate enhanced resource efficiency by allowing multiple containers to run on a single system. Resource efficiency is a natural result of the isolation and allocation techniques that containers use. Containers may be restricted to a certain number of CPUs and allocated specific amounts of memory. Docker is an example of a set of platform-as-a-service products that use OS-level virtualization to deliver software in containers.

To bootstrap Notebook sessions, a cloud provider may offer limited runtime configuration options, such as the ability to specify custom environment variables and clone Git repositories. However, some customers (or users of the cloud) require more specific control over their respective Notebook sessions, particularly during activation and deactivation. For example, some customers may need to configure a proxy when a Notebook session is activated or delete sensitive files when a Notebook session is deactivated. Since these runtime configuration requests vary from customer to customer and lack standardization, every use case cannot be addressed by including those use cases in a cloud API. Therefore, embodiments allow cloud providers the ability to offer cloud users a mechanism to specify their desired behavior, which will enable cloud providers to meet the unique requirements of cloud users.

While Notebook sessions is one type of IDE session, the following description is in the context of IDE sessions, or simply “sessions.” Embodiments are not limited to any particular IDE, such as Notebook or substitutes thereof.

### General Overview

A system and method for managing IDE sessions in a cloud environment are provided. In one technique, a cloud system allows cloud users to provide scripts by passing storage references (e.g., URLs) when creating or activating a session. In one technique, scripts correspond to different session lifecycle states, such as creation, activation, deactivation, and deletion. The cloud system manages execution of those scripts.

In a related technique, upon completion of a session, a deactivate or delete script associated with the session is automatically identified and executed before the virtual machine (VM) that is running the session is terminated. A VM process receives a delete or deactivate call and sends a termination signal to the container in which the session is residing. The container traps the termination signal and executes the deactivate or delete script.

Embodiments improve computer-related technology related to the management of IDE sessions in a cloud environment. Prior to embodiments, cloud users would have to create scripts, launch IDE sessions, copy scripts into the IDE sessions, and manually set up scheduling of those scripts. With embodiments, all this information is passed in at IDE session creation time and execution of these scripts is automatically scheduled without user input. Prior to embodiments, once a cloud user provides input to end or terminate an IDE session, no further user input could be provided and no scripts could be executed. With embodiments, upon input to end an IDE session, a lifecycle script is automatically identified and executed prior to termination of the virtual machine on which the IDE session resides.

### System Overview

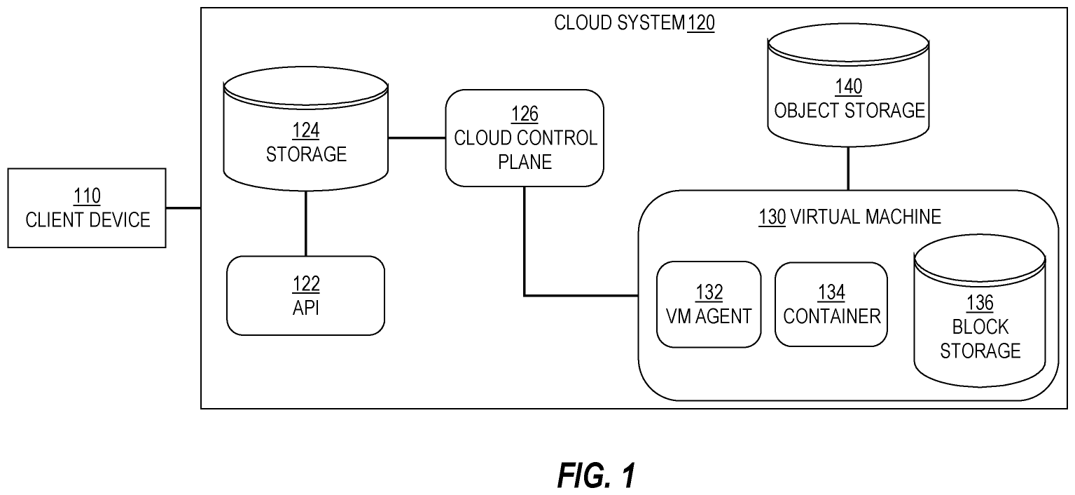

FIG. 1 is a block diagram that depicts an example system architecture 100 for executing life cycle scripts, in an embodiment. System architecture 100 includes a client device 110 and a cloud system 120 that hosts and manages IDE sessions on behalf of client device 110. Although only a single client device is depicted, multiple client devices may be communicatively coupled to cloud system 120 over one or more computer networks, such as the Internet.

Cloud system 120 comprises an application programming interface (API) 122, a storage 124, a cloud control plane 126, a virtual machine 130, and object storage 140. The depicted components of cloud system 120 is one way in which cloud system 120 may be implemented, but embodiments are not limited to this particular way.

Client device 110 displays a user interface for interacting with cloud system 120. Through the user interface, a user provides input, such as input to create a new IDE session or input to reactivate an existing IDE session. The input may comprise selecting a graphical button after inputting one or more references into one or more text input fields. Each reference uniquely identifies a script that is stored in object storage 140. A reference may comprise path data that identifies a series of one or more folders or directories separated by forward or backward slashes. (An example of path data is the following uniform resource locator (URL): https://objectstorage.region.oraclecloud.com/n/object-storage-namespace/b/bucket/o/filename.) Thus, a user of client device 110 may have stored the script in object storage 140 prior to providing the input to create a new IDE session or to reactivate an existing IDE session.

If there are multiple text input fields in the user interface, then each text input field may be associated with a label, in the user interface, that indicates the type of lifecycle script. Thus, one text input field may be for a CREATE script, another text input field may be for a ACTIVATE script, etc. In this way, the cloud user may specify a different path in each of the text input fields. Alternatively, each reference may include a name that indicates the type of lifecycle script.

In an embodiment, client device 110 (based on input from a cloud user) provides one or more lifecycle script environment variable key-value pairs in a payload that is sent to API 122 and eventually sent to cloud control plane 126. Examples of environment variables related to lifecycle scripts are the following (along with a brief description):

| | |
|---|---|
| ONCREATE_SCRIPT_URL | script execution hook at creation time only |
| ONACTIVATE_SCRIPT_URL | script execution hook at activation time only |
| ONDEACTIVATE_SCRIPT_URL | script execution hook at deactivation time only |
| ONDELETE_SCRIPT_URL | script execution hook at delete time only |
| SCRIPT_OUTPUT_LOG_NAMESPACE | Object Storage namespace for execution logs in |
| | cloud user tenancy |
| SCRIPT_OUTPUT_LOG_BUCKET | Object Storage bucket for execution logs in cloud |
| | user tenancy |

Thus, a script environment variable key that is included in input from client device 110 may be one of the variable names listed above and a value of that key may be an actual reference or URL. A set of one or more key-value pairs may be part of the runtime configuration that is passed to a virtual machine (described in more detail herein) as compute extended metadata during provisioning of a compute instance.

API 122 receives input from client device 110 over one or more computer networks, such as one or more local area networks (LANs), one or more wide area networks (WANs), and/or the Internet. The input includes an instruction to create or activate an IDE session and one or more references to one or more scripts, which are stored in object storage 140. API 122 stores the instruction and reference(s) in storage 124. Storage 124 may be persistent, or non-volatile, storage, such as a hard disk drive (HDD) or a solid state drive (SSD).

Cloud control plane 126 is a process that polls or checks storage 124 to detect instructions from cloud users. Such polling may occur periodically, such as every second or minute, for new data. In response to detecting that a create or activate instruction has been stored in storage 124, cloud control plane 126 retrieves the instruction and corresponding reference(s), and causes a compute instance to be created, i.e., virtual machine 130. Thus, prior to cloud control plane 126 detecting the new instruction in storage 124, virtual machine 130 did not exist for client device 110. The instruction to create virtual machine 130 may include a VM image. The VM image may be based on any Linux-based OS image, upon which all other components are bootstrapped.

As part of the boot up process, virtual machine 130 that will host an IDE session is created. The call to create virtual machine 130 includes extended metadata that includes one or more references to one or more (lifecycle) scripts. The one or more references originated from client device 110 when sending a create/activate session instruction to API 122.

VM 130 includes a VM agent 132, a container 134, and block storage 136, which is attached/mounted to VM 130. VM agent 132 checks the runtime configuration from the extended metadata, identifies the one or more references, and uses the one or more references to download the corresponding lifecycle scripts from object storage 140. The one or more references may point to a specific bucket or location, in object storage 140, that is associated with the cloud user. The call to download may include a resource principal token. The one or more corresponding lifecycle scripts are downloaded to a mounted home directory of container 134, which directory persists on block storage 136 that is attached to VM 130. VM agent 132 triggers execution of CREATE and ACTIVATE scripts inside container 134 at container runtime.

Progress information and script execution logs may be written to session runtime configuration logs (e.g., at “/opt/logs/odsc.log”), which a cloud user can access from within their IDE session. A script execution log may indicate a success, failure, or pending status. A script execution log may also indicate a time that elapsed from the start of script execution to an end of script execution. Additionally, a script execution log may indicate a time that elapsed for each task indicated in the corresponding script. A cloud statistics generator (not depicted) may then analyze such logs and generate statistics on a per cloud user basis, such as a number of script execution failures and successes, a mean and median time of script execution across multiple scripts, and a mean and median time of task execution of a particular task across multiple scripts. The cloud statistics generator may generate such statistics on a per lifecycle script basis. For example, for DELETE scripts, there is one mean execution time and for ACTIVATE scripts, there is a separate mean execution time.

On each deactivate session action, container 134 preserves the lifecycle scripts on block storage 136. Although VM 130 is terminated when the IDE session is deactivated, user data, including lifecycle scripts, is persisted on block storage 136, which is mounted to a new VM when the IDE session is activated again. During session activation, the new VM agent syncs objects in object storage 140 with local block storage scripts, downloading only new and updated scripts determined by comparing files checksum. This allows cloud users to provide new scripts when an IDE session is activated.

If a cloud user needs to make changes to the DELETE or DEACTIVATE lifecycle scripts, then simply changing the script in object storage 140 after an IDE session starts is not sufficient, as the scripts might be only downloaded during IDE session runtime. Instead, in an embodiment, the cloud user deactivates and reactivates their IDE session for any changes to take effect. In a related embodiment, a cloud user is able to change (e.g., modify or replace) a delete or deactivate script during an IDE session, without having to deactivate and reactivate the IDE session.

### Create and Activate Scripts

CREATE and ACTIVATE scripts run at the start of an IDE session, inside a container, such as container 134. An entry point of container 134 starts two background forks (or processes): one background fork for script execution, which returns after completion or timeout, and the other background fork for a server process, which returns only after shutdown. Both lifecycle script execution and the server process may be executed simultaneously. VM agent 132 calls a container engine API to start a container process (i.e., container 134) and then the two process forks begin. The container process is the parent process. A (e.g., Docker) container process has a network interface that is configured by a cloud user or customer. In contrast, VM agent 132 runs in a service-managed network interface. For lifecycle script execution, the customer-managed network interface is not used; instead, dataflow happens on the service-managed network interface.

One purpose that the server process serves is to display a user interface (UI) to allow a cloud user to interact with the IDE session. In the context of machine learning, the server process also executes one or more machine-learned models.

An example of an operation that is included in a CREATE or ACTIVATE script and that is performed (by one of the background forks/processes) when the lifecycle script is executed is downloading results (e.g., in object storage 140) that are generated by a machine-learned model that (1) was trained in a previous IDE session of a cloud user that triggers the lifecycle script and (2) is storing those results continuously.

In an embodiment, CREATE and ACTIVATE scripts are non-blocking, which ensures that the container will start without delay and will execute one of the scripts in parallel with the container.

As previously mentioned, VM agent 132 reads lifecycle script environment variables from the extended metadata, downloads the scripts to block storage 136 attached to VM 130, and manages the execution of the CREATE or ACTIVATE scripts as necessary. Cloud users may provide the same script path for each script or may provide different script paths for each script. Based on cloud user requests, many use cases involve script execution during session CREATE or ACTIVATE workflows. Examples of such use cases include downloading datasets, installing packages and Conda packs (a type of execution environment, including support libraries), and adding DNS configurations.

In an embodiment, a variation of creating or activating an IDE session is ensuring that the corresponding lifecycle script completes prior to starting up the “main” server process of container 134. There might be some data or packages that need to be installed or available when the server process starts or boots up.

### Delete and Deactivate Scripts

Prior to an IDE session being deleted or deactivated, some cloud users desire certain operations to be performed. For example, requirements for a cloud user may be to (1) securely delete all base data that the cloud user has accessed during an IDE session and (2) securely store aggregated data that is based on the base data and excludes any user identifiable information (UII). These requirements may be reflected in a DEACTIVATE script that includes operations to be performed by container 134. In current approaches to deleting or deactivating IDE sessions, if a cloud user (perhaps unintentionally) provides input to delete or deactivate an IDE session before providing input to execute a lifecycle script, then the lifecycle script would not be executed prior to deletion/deactivation.

When a cloud user deactivates or deletes an IDE session, the corresponding VM that hosts the IDE session is terminated. DEACTIVATE and DELETE scripts run inside container 134 prior to this termination. Cloud users can specify different references (e.g., URLs) for each script or use the same reference for both. These references may be specified at session creation or activation time.

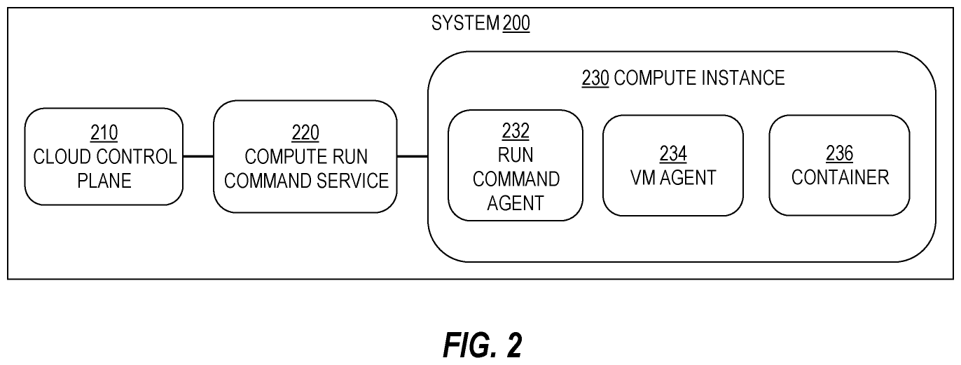

FIG. 2 is a block diagram that depicts an example system 200 for processing a delete or deactivate workflow, in an embodiment. System 200 comprises a cloud control plane 210 (corresponding to cloud control plane 126), a compute run command service 220, and a compute instance 230 (corresponding to VM 130). Each of these three components executes within the same cloud environment and may be developed and/or maintained by different software engineer teams. Although only one compute instance is depicted in FIG. 2, system 200 may comprise multiple compute instances, each executing in a cloud system and corresponding to a different cloud user, whether an individual or enterprise. Thus, compute run command service 220 may be communicatively coupled with multiple compute instances.

When a cloud user is finished with an IDE session, a UI (that is displayed to the cloud user on a screen of a client device of the cloud user) provides one or more options, such as a delete session option and a deactivate option. A cloud user provides input through the UI, such as selecting (e.g., via a touchscreen, via a cursor control device associated with the client device, or via a keyboard connected to the client device) one of those options, which causes data to be transmitted from the client device to cloud system 120. The data indicates a delete command or a deactivate command, depending on which option the cloud user selected. The data may also include a user identifier that identifies a cloud user that initiated the command and/or a session identifier that identifies the IDE session that is to be deleted/deactivated.

Within cloud system 120, cloud control plane 210 receives the data and, in response, activates a delete/deactivate workflow. Activating the workflow causes cloud control plane 210 to send a command (delete or deactivate) to compute run command service 220. In turn, compute run command service 220 stores the command, such as in persistent storage, in association with a compute instance identifier and/or a session (or user) identifier. Compute run command service 220 waits for a run command agent 232 executing within compute instance 230 to poll for user-initiated commands. Such polling may occur frequently, such as every second. A poll may include a compute instance identifier (and/or session identifier), which acts a key for retrieving pending commands for that computer instance or session. Compute run command service 220 responds to a poll by locating the command, in (local) storage, that is associated with the same compute instance identifier (and/or session (or user) identifier) as the identifier(s) in the poll, and transmitting the command to run command agent 232. In response to receiving the command from compute run command service 220, run command agent 232 sends a termination signal to a VM agent 234 (which corresponds to VM agent 132). In response to receiving the termination signal, VM agent 234 triggers a graceful shutdown of a container 236, which corresponds to container 134.

In an embodiment, VM agent 234 is modified to host an API endpoint to support this graceful shutdown functionality. Run command agent 232 calls a /delete endpoint or a /deactivate endpoint of an API of VM agent 234 (depending on the type of termination indicated in the termination signal from run command agent 232) and polls until a /health endpoint returns a shutdown success. In response to receiving a DELETE or DEACTIVATE call from run command agent 232, VM agent 234 sends a termination signal to an executing container (e.g., container 134), which traps the signal and causes (e.g., via a script process) either a DELETE or DEACTIVATE script to be executed. If the appropriate script is not in storage, then the container shuts down. Alternatively, if the appropriate script is not in storage, then an attempt to download the appropriate script to the storage is made. In the scenario where the appropriate script is in storage and the script is executed, if the script execution exceeds a threshold time period (e.g., 15 minutes), then VM agent 234 sends a kill signal to the container. The session deactivation or deletion workflow of cloud control plane 210 waits for a response from compute run command service 220 to indicate either a success, failure, or timeout before continuing with the rest of the workflow steps. Thus, cloud control plane 210 creates one run command based on a user (delete or deactivate) action. Run command execution is taken care of by run command agent 232 running on compute instance 230. Cloud control plane 210 waits for run command execution.

In an embodiment, prior to sending, to compute run command service 220, a delete/deactivate command pertaining to an IDE session, cloud control plane 210 determines whether the IDE session is associated with a corresponding lifecycle script. This determination may involve cloud control plane 210 retrieving a session entity from storage (e.g., storage 124) and checking one or more values in an environment variables map. If a reserved environment variable key is present in the session entity, then a run command is created with a timeout period (e.g., 15 minutes). This run command results in an API call to VM agent 234 to shutdown the corresponding container.

In a related embodiment, cloud control plane 210 periodically checks the status of the run command execution. Such a check may involve cloud control plane 210 calling compute run command service 220, which may have been updated in the meantime by compute instance 230 regarding the status of the lifecycle script execution. If compute run command service 220 indicates (to cloud control plane 210) that the run command execution is pending or in progress, then cloud control plane 210 checks again later until there is a success, failure, or timeout.

### IDE Session Container at Delete/Deactivate Time

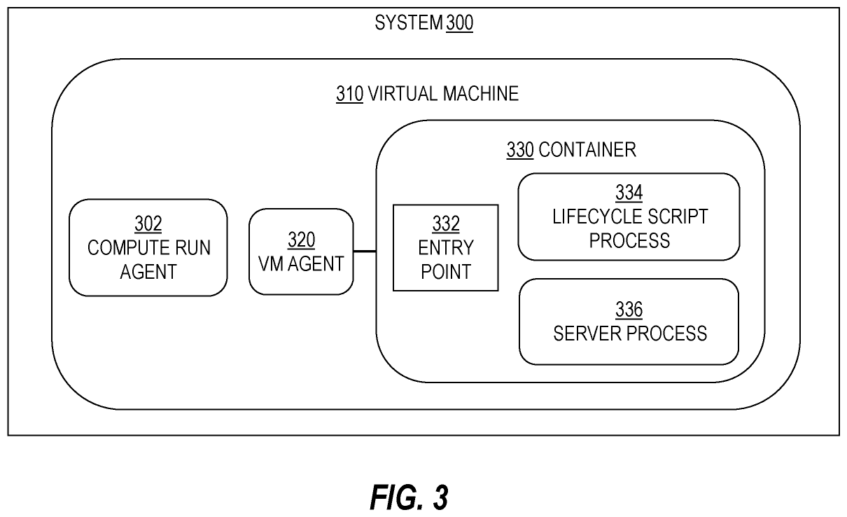

FIG. 3 is a block diagram that depicts an example system 300 that includes a container 330 within a virtual machine 310, in an embodiment. Lifecycle scripts are executed within container 330. During bootstrapping, VM agent 320 downloads lifecycle scripts to a home directory of container 330. Upon container initialization, a CREATE or ACTIVATE script executes in parallel to a server process executing within container 330, minimizing any delay in IDE session provisioning time.

When it comes time to deactivating or deleting the IDE session, workflows trigger a graceful shutdown of container 330. A run command service 302 (which is outside of virtual machine 310) calls a delete or deactivate API of VM agent 320. In response, VM agent 320 sends a termination signal to container 330. The termination signal is either a delete signal or a deactivate signal.

As depicted in FIG. 3 container 330 comprises an entry point 332, a lifecycle script process 334 (which executes lifecycle scripts), and a server process 336, which is the main process of container 330. Entry point 332 receives a termination signal from VM agent 320. Entry point 332 forwards the termination signal to both lifecycle script process 334 and server process 336. Server process 336 shuts down immediately, whereas lifecycle script process 334 looks for script presence and executes the script (if it exists) before shutting down. Specifically, lifecycle script process 334 determines whether the termination signal is a delete signal or a deactivate signal. If the former, then lifecycle script process 334 retrieves the DELETE script from local storage and executes the lifecycle script; otherwise, lifecycle script process 334 retrieves the DEACTIVATE script from local storage and executes the lifecycle script. Container 330 only shuts down after script execution has finished or the timeout has been reached.

### Updating Scripts

While an IDE session is active, a cloud user might change a lifecycle script or add a new lifecycle script, such as a DELETE script or a DEACTIVATE script. However, in order to leverage such a change in scripts, one of two approaches may be used.

In a first approach, the cloud user updates a lifecycle script in object storage (e.g., object storage 140), from which lifecycle scripts are downloaded into storage of a virtual machine at container runtime. The cloud user provides first input (either before the update or after the update) that causes deactivation of the IDE session, which ensures that any data that is part of the IDE session is preserved in storage and is brought back when the IDE is reactivated. After the update to the lifecycle script and the first input, the cloud user provides second input that causes activation of the IDE session. Upon activation, the updated lifecycle script is downloaded into storage of a virtual machine associated with the reactivated IDE session.

In a variation of this approach, instead of updating the lifecycle script, the cloud user stores a different lifecycle script into the object storage, which lifecycle script will replace the previous lifecycle script. Then, in the second input, the second input includes a reference to a location of that different lifecycle script to allow the new container to download the different lifecycle script into local storage.

In a second approach, the cloud user provides first input that includes a reference to a lifecycle script and an instruction to download the lifecycle script (e.g., from object storage 140) immediately or before shutdown of the container in question. A lifecycle script process (executing in the container in question) receives this instruction and reference (e.g., through one or more computing entities) and downloads the lifecycle script into local storage of the container.

### Process Overview for Terminating a Session

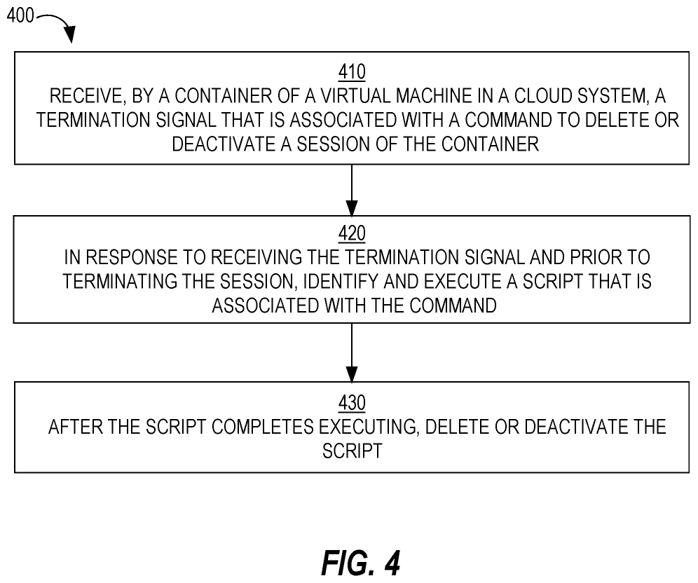

FIG. 4 is a flow diagram that depicts an example process 400 for deleting or deactivating a session of a container in a cloud system, in an embodiment. Process 400 may be performed by different elements of system 200 and/or system 300.

At block 410, a termination signal is received by the container of a virtual machine in the cloud system. The termination signal is associated with a command to delete or deactivate the session of the container. Block 410 may be preceded by an agent of the virtual machine (which agent is separate from the container) receiving input that indicates the command pertaining to the session. In response, the agent generates and transmits, to the container, the termination signal.

At block 420, in response to receiving the termination signal and prior to terminating the session, a script that is associated with the command is identified and executed. Block 420 may be performed by a script execution process within the container. Block 420 may also comprise determining whether the termination signal is a delete session signal or a deactivate session signal. Thus, the script execution process determines that type of signal and retrieves, from local storage, the appropriate lifecycle script and begins executing the script.

At block 430, after the script completes executing, the session is deleted or deactivated. Block 430 may involve determining whether the script has completed (either in success or failure). If the script has completed, then the container is deleted. If the termination signal is a deactivate session signal, then block 430 involves saving session data prior to deleting the container. Deleting the container comprises terminating the main container server process and cleaning up (e.g., deallocating any memory associated with) the session.

### Process Overview for Starting a Session

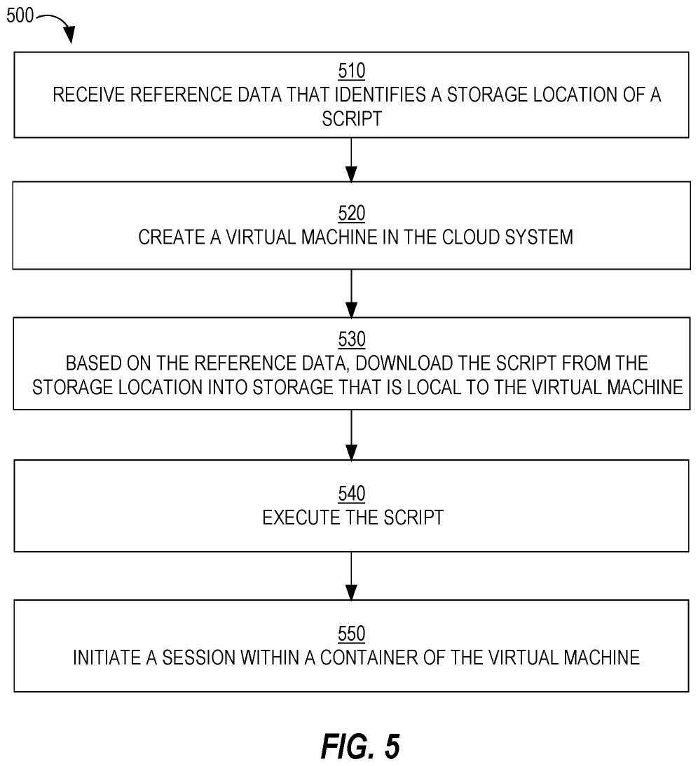

FIG. 5 is a flow diagram that depicts an example process 500 for starting a session, in an embodiment. Process 500 may be performed by different elements of cloud system 120 and/or system 200.

At block 510, reference data that identifies a storage location of a script is received at a cloud system. Block 510 may be performed by a component or element of cloud system 120, such as cloud control plane 126 or VM 130. The reference data may have originally been specified by a user of the cloud system, operating a client device (e.g., client device 110) that is communicatively coupled to the cloud system.

At block 520, a virtual machine in the cloud system is created. Receiving of the reference data may trigger creation of the virtual machine.

At block 530, based on the reference data, the script is downloaded from the storage location into storage that is local to the virtual machine. Block 530 may be performed by an agent of the virtual machine.

At block 540, the script is executed. Block 540 may also involve a script execution process within a container of the virtual machine starting up and receiving storage data of the script from an agent of the virtual machine and then executing the script.

At block 550, a session within a container of the virtual machine is started or initiated. If the reference data is associated with an activate session command, then block 550 may involve retrieving session data from session storage. The session data was generated or managed by a previous session that was active previous to the session that is started or initiated in block 550 and that is associated with the same cloud user/entity. If the reference data is associated with a create session command, then block 550 involves starting a clean or fresh session that does not include any session data from a previous session.

Block 550 may occur concurrently with block 540. For example, block 540 may involve (1) retrieving results produced by a machine-learned model that has been executing between sessions of the cloud user with the cloud system and (2) storing the results in memory of the virtual machine for future accessing and, optionally, displaying via the container.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

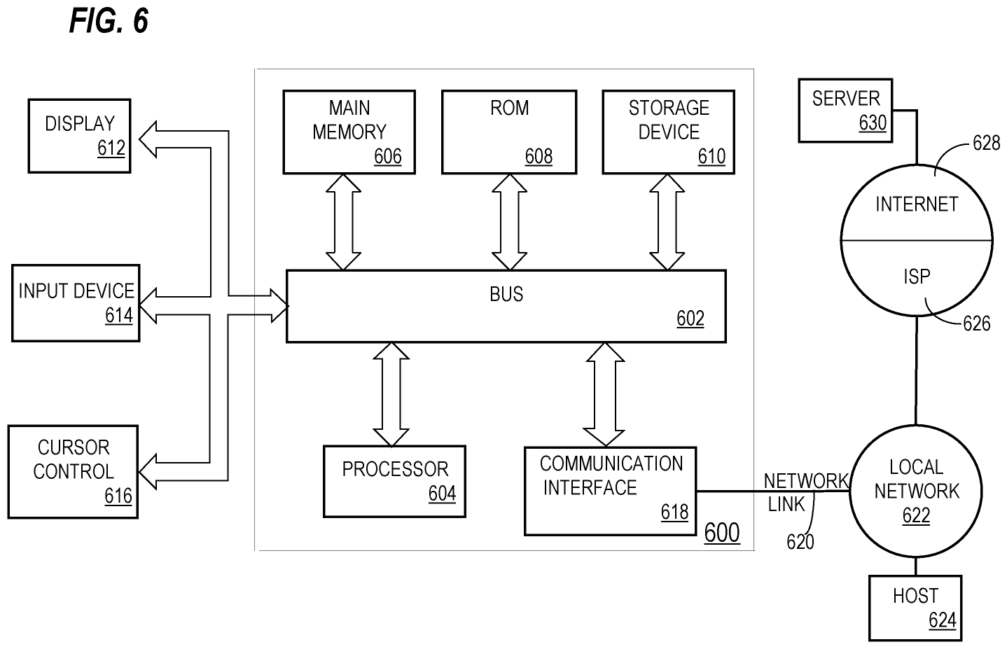

For example, FIG. 6 is a block diagram that illustrates a computer system 600 upon which an embodiment of the invention may be implemented. Computer system 600 includes a bus 602 or other communication mechanism for communicating information, and a hardware processor 604 coupled with bus 602 for processing information. Hardware processor 604 may be, for example, a general purpose microprocessor.

Computer system 600 also includes a main memory 606, such as a random access memory (RAM) or other dynamic storage device, coupled to bus 602 for storing information and instructions to be executed by processor 604. Main memory 606 also may be used for storing temporary variables or other intermediate information during execution of instructions to be executed by processor 604. Such instructions, when stored in non-transitory storage media accessible to processor 604, render computer system 600 into a special-purpose machine that is customized to perform the operations specified in the instructions.

Computer system 600 further includes a read only memory (ROM) 608 or other static storage device coupled to bus 602 for storing static information and instructions for processor 604. A storage device 610, such as a magnetic disk, optical disk, or solid-state drive is provided and coupled to bus 602 for storing information and instructions.

Computer system 600 may be coupled via bus 602 to a display 612, such as a cathode ray tube (CRT), for displaying information to a computer user. An input device 614, including alphanumeric and other keys, is coupled to bus 602 for communicating information and command selections to processor 604. Another type of user input device is cursor control 616, such as a mouse, a trackball, or cursor direction keys for communicating direction information and command selections to processor 604 and for controlling cursor movement on display 612. This input device typically has two degrees of freedom in two axes, a first axis (e.g., x) and a second axis (e.g., y), that allows the device to specify positions in a plane.

Computer system 600 may implement the techniques described herein using customized hard-wired logic, one or more ASICs or FPGAs, firmware and/or program logic which in combination with the computer system causes or programs computer system 600 to be a special-purpose machine. According to one embodiment, the techniques herein are performed by computer system 600 in response to processor 604 executing one or more sequences of one or more instructions contained in main memory 606. Such instructions may be read into main memory 606 from another storage medium, such as storage device 610. Execution of the sequences of instructions contained in main memory 606 causes processor 604 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 610. Volatile media includes dynamic memory, such as main memory 606. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 602. Transmission media can also take the form of acoustic or light waves, such as those generated during radio-wave and infra-red data communications.

Various forms of media may be involved in carrying one or more sequences of one or more instructions to processor 604 for execution. For example, the instructions may initially be carried on a magnetic disk or solid-state drive of a remote computer. The remote computer can load the instructions into its dynamic memory and send the instructions over a telephone line using a modem. A modem local to computer system 600 can receive the data on the telephone line and use an infra-red transmitter to convert the data to an infra-red signal. An infra-red detector can receive the data carried in the infra-red signal and appropriate circuitry can place the data on bus 602. Bus 602 carries the data to main memory 606, from which processor 604 retrieves and executes the instructions. The instructions received by main memory 606 may optionally be stored on storage device 610 either before or after execution by processor 604.

Computer system 600 also includes a communication interface 618 coupled to bus 602. Communication interface 618 provides a two-way data communication coupling to a network link 620 that is connected to a local network 622. For example, communication interface 618 may be an integrated services digital network (ISDN) card, cable modem, satellite modem, or a modem to provide a data communication connection to a corresponding type of telephone line. As another example, communication interface 618 may be a local area network (LAN) card to provide a data communication connection to a compatible LAN. Wireless links may also be implemented. In any such implementation, communication interface 618 sends and receives electrical, electromagnetic or optical signals that carry digital data streams representing various types of information.

Network link 620 typically provides data communication through one or more networks to other data devices. For example, network link 620 may provide a connection through local network 622 to a host computer 624 or to data equipment operated by an Internet Service Provider (ISP) 626. ISP 626 in turn provides data communication services through the world wide packet data communication network now commonly referred to as the “Internet” 628. Local network 622 and Internet 628 both use electrical, electromagnetic or optical signals that carry digital data streams. The signals through the various networks and the signals on network link 620 and through communication interface 618, which carry the digital data to and from computer system 600, are example forms of transmission media.

Computer system 600 can send messages and receive data, including program code, through the network(s), network link 620 and communication interface 618. In the Internet example, a server 630 might transmit a requested code for an application program through Internet 628, ISP 626, local network 622 and communication interface 618.

The received code may be executed by processor 604 as it is received, and/or stored in storage device 610, or other non-volatile storage for later execution.

### Software Overview

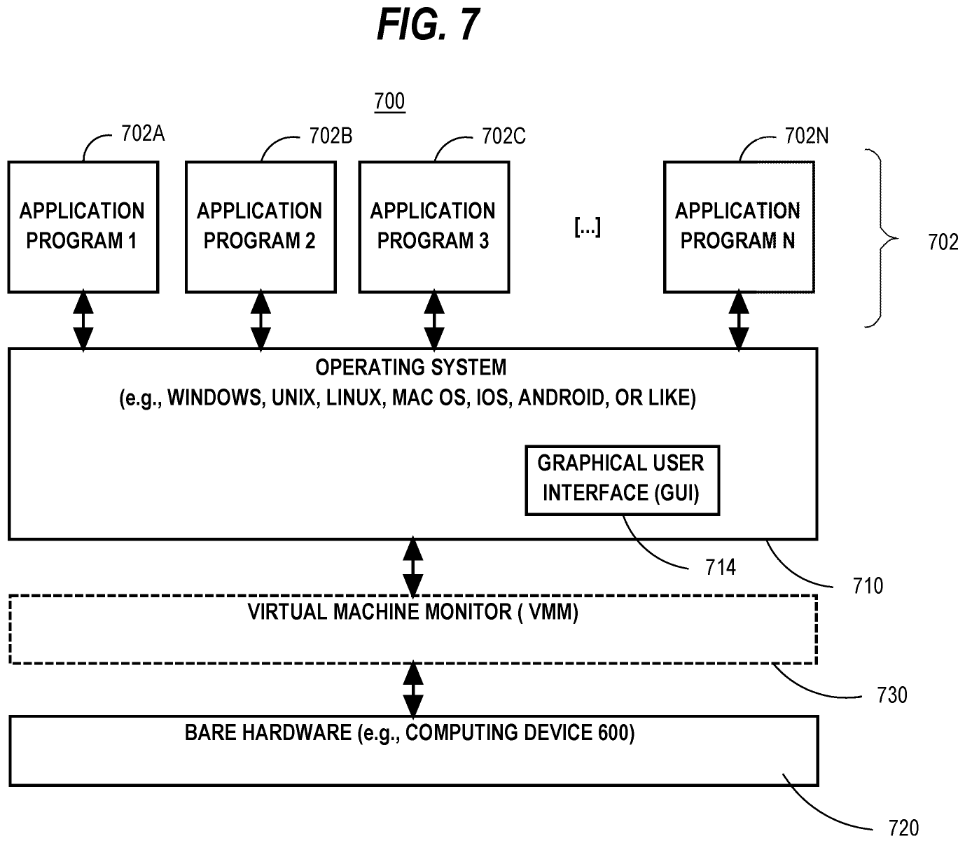

FIG. 7 is a block diagram of a basic software system 700 that may be employed for controlling the operation of computer system 600. Software system 700 and its components, including their connections, relationships, and functions, is meant to be exemplary only, and not meant to limit implementations of the example embodiment(s). Other software systems suitable for implementing the example embodiment(s) may have different components, including components with different connections, relationships, and functions.

Software system 700 is provided for directing the operation of computer system 600. Software system 700, which may be stored in system memory (RAM) 606 and on fixed storage (e.g., hard disk or flash memory) 610, includes a kernel or operating system (OS) 710.

The OS 710 manages low-level aspects of computer operation, including managing execution of processes, memory allocation, file input and output (I/O), and device I/O. One or more application programs, represented as 702A, 702B, 702C . . . 702N, may be “loaded” (e.g., transferred from fixed storage 610 into memory 606) for execution by the system 700. The applications or other software intended for use on computer system 600 may also be stored as a set of downloadable computer-executable instructions, for example, for downloading and installation from an Internet location (e.g., a Web server, an app store, or other online service).

Software system 700 includes a graphical user interface (GUI) 715, for receiving user commands and data in a graphical (e.g., “point-and-click” or “touch gesture”) fashion. These inputs, in turn, may be acted upon by the system 700 in accordance with instructions from operating system 710 and/or application(s) 702. The GUI 715 also serves to display the results of operation from the OS 710 and application(s) 702, whereupon the user may supply additional inputs or terminate the session (e.g., log off).

OS 710 can execute directly on the bare hardware 720 (e.g., processor(s) 604) of computer system 600. Alternatively, a hypervisor or virtual machine monitor (VMM) 730 may be interposed between the bare hardware 720 and the OS 710. In this configuration, VMM 730 acts as a software “cushion” or virtualization layer between the OS 710 and the bare hardware 720 of the computer system 600.

VMM 730 instantiates and runs one or more virtual machine instances (“guest machines”). Each guest machine comprises a “guest” operating system, such as OS 710, and one or more applications, such as application(s) 702, designed to execute on the guest operating system. The VMM 730 presents the guest operating systems with a virtual operating platform and manages the execution of the guest operating systems.

In some instances, the VMM 730 may allow a guest operating system to run as if it is running on the bare hardware 720 of computer system 600 directly. In these instances, the same version of the guest operating system configured to execute on the bare hardware 720 directly may also execute on VMM 730 without modification or reconfiguration. In other words, VMM 730 may provide full hardware and CPU virtualization to a guest operating system in some instances.

In other instances, a guest operating system may be specially designed or configured to execute on VMM 730 for efficiency. In these instances, the guest operating system is “aware” that it executes on a virtual machine monitor. In other words, VMM 730 may provide para-virtualization to a guest operating system in some instances.

A computer system process comprises an allotment of hardware processor time, and an allotment of memory (physical and/or virtual), the allotment of memory being for storing instructions executed by the hardware processor, for storing data generated by the hardware processor executing the instructions, and/or for storing the hardware processor state (e.g. content of registers) between allotments of the hardware processor time when the computer system process is not running. Computer system processes run under the control of an operating system, and may run under the control of other programs being executed on the computer system.

The above-described basic computer hardware and software is presented for purposes of illustrating the basic underlying computer components that may be employed for implementing the example embodiment(s). The example embodiment(s), however, are not necessarily limited to any particular computing environment or computing device configuration. Instead, the example embodiment(s) may be implemented in any type of system architecture or processing environment that one skilled in the art, in light of this disclosure, would understand as capable of supporting the features and functions of the example embodiment(s) presented herein.

### Cloud Computing

The term “cloud computing” is generally used herein to describe a computing model which enables on-demand access to a shared pool of computing resources, such as computer networks, servers, software applications, and services, and which allows for rapid provisioning and release of resources with minimal management effort or service provider interaction.

A cloud computing environment (sometimes referred to as a cloud environment, or a cloud) can be implemented in a variety of different ways to best suit different requirements. For example, in a public cloud environment, the underlying computing infrastructure is owned by an organization that makes its cloud services available to other organizations or to the general public. In contrast, a private cloud environment is generally intended solely for use by, or within, a single organization. A community cloud is intended to be shared by several organizations within a community; while a hybrid cloud comprises two or more types of cloud (e.g., private, community, or public) that are bound together by data and application portability.

Generally, a cloud computing model enables some of those responsibilities which previously may have been provided by an organization's own information technology department, to instead be delivered as service layers within a cloud environment, for use by consumers (either within or external to the organization, according to the cloud's public/private nature). Depending on the particular implementation, the precise definition of components or features provided by or within each cloud service layer can vary, but common examples include: Software as a Service (SaaS), in which consumers use software applications that are running upon a cloud infrastructure, while a SaaS provider manages or controls the underlying cloud infrastructure and applications. Platform as a Service (PaaS), in which consumers can use software programming languages and development tools supported by a PaaS provider to develop, deploy, and otherwise control their own applications, while the PaaS provider manages or controls other aspects of the cloud environment (i.e., everything below the run-time execution environment). Infrastructure as a Service (IaaS), in which consumers can deploy and run arbitrary software applications, and/or provision processing, storage, networks, and other fundamental computing resources, while an IaaS provider manages or controls the underlying physical cloud infrastructure (i.e., everything below the operating system layer). Database as a Service (DBaaS) in which consumers use a database server or Database Management System that is running upon a cloud infrastructure, while a DbaaS provider manages or controls the underlying cloud infrastructure, applications, and servers, including one or more database servers.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
receiving, by a container of a virtual machine, a termination signal that is associated with a command to delete or deactivate a session of the container;
in response to receiving the termination signal and prior to terminating the session, identifying and executing, by the container, a script that is associated with the command;
after the script completes executing, deleting or deactivating the session;
wherein the method is performed by one or more computing devices.

2. The method of claim 1, further comprising:
receiving, by an agent of the virtual machine, input that indicates the command relative to the session of the container of the virtual machine, wherein the command is to delete or deactivate the session;
in response to receiving the input, generating and transmitting, by the agent, the termination signal;
wherein the container receives the termination signal from the agent.

3. The method of claim 2, wherein identifying and executing the script comprises a script execution process of the container identifying and executing the script, wherein the script execution process is different than a server process, of the container, that provides a user interface to a computing device of a cloud user that initiated the session.

4. The method of claim 1, further comprising:
determining whether the termination signal is associated with a delete session command or a deactivate session command;
if the termination signal is associated with a delete session commend, then identifying the script comprises identifying a delete script;
if the termination signal is associated with a deactivation session commend, then identifying the script comprises identifying a deactivation script.

5. The method of claim 1, further comprising, prior to receiving the input:
receiving reference data that identifies a storage location of the script;
in response to receiving the reference data, downloading, from the storage location, the script to storage that is local to the virtual machine.

6. The method of claim 5, wherein identifying the script comprises retrieving the script from the storage that is local to the virtual machine.

7. The method of claim 1, further comprising:
sending, from a compute instance upon which the session resides, to a command service that is separate from the compute instance, a command request for one or more commands for the session;
wherein receiving the input is performed in response to sending the command request.

8. The method of claim 7, further comprising, prior to the compute instance sending the command request to the command service:
receiving, at the command service, from a cloud control plane, a notification that a user, of the session, selected a delete or deactivate option associated with the session;
in response to receiving the notification, storing the notification in storage that is local to the command service;
wherein the notification includes a compute instance identifier that identifies the compute instance or a session identifier that identifies the session.

9. The method of claim 1, further comprising:
receiving second input that indicates a second command relative to a second session of a second container of a second virtual machine in the cloud system;
in response to receiving the second input, generating and transmitting a second termination signal;
prior to terminating the second session, identifying and executing a second script that is associated with the second command;
determining whether a time period from the start of executing the second script to a current time exceeds a timeout period;
in response to determining that the time period exceeds the timeout period, deleting or deactivating the second session without waiting for execution of the second script to complete.

10. A method comprising:
receiving, at a cloud system, reference data that identifies a storage location of a script;
creating a virtual machine in the cloud system;
based on the reference data, downloading the script from the storage location into storage that is local to the virtual machine;
executing the script;
initiating a session within a container of the virtual machine;
wherein the method is performed by one or more computing devices.

11. The method of claim 10, wherein the reference data identifies a storage location of a plurality of scripts that includes the script, wherein downloading the script comprises downloading the plurality of scripts to the storage.

12. The method of claim 11, wherein the plurality of scripts comprises two or more of a create session script, an activate session script, a deactivate session script, or a delete session script.

13. The method of claim 10, further comprising:
initiating a first server container process for providing a user interface to a cloud user of the session;
initiating a second server container process, that is different than the first server container process, for executing lifecycle scripts.

14. The method of claim 10, wherein executing the script comprises:
based on the script being an activate session script, retrieving, from second storage, results that were generated by a machine-learned model that was trained in a previous session that was active previous to the session.

15. The method of claim 10, wherein initiating the session comprises:
retrieving, from second storage, session data that was generated in a previous session that was deactivated prior to receiving the reference data.

16. One or more non-transitory storage media storing instructions which, when executed by one or more computing devices, cause:
receiving, by a container of a virtual machine, a termination signal that is associated with a command to delete or deactivate a session of the container;
in response to receiving the termination signal and prior to terminating the session, identifying and executing, by the container, a script that is associated with the command;
after the script completes executing, deleting or deactivating the session.

17. The one or more storage media of claim 16, wherein the instructions, when executed by the one or more computing devices, further cause:
receiving, by an agent of the virtual machine, input that indicates the command relative to the session of the container of the virtual machine, wherein the command is to delete or deactivate the session;
in response to receiving the input, generating and transmitting, by the agent, the termination signal;
wherein the container receives the termination signal from the agent.

18. The one or more storage media of claim 17, wherein:
identifying and executing the script comprises a script execution process of the container identifying and executing the script;
the script execution process is different than a server process, of the container, that provides a user interface to a computing device of a cloud user that initiated the session.

19. The one or more storage media of claim 16, wherein the instructions, when executed by the one or more computing devices, further cause:
determining whether the termination signal is associated with a delete session command or a deactivate session command;
if the termination signal is associated with a delete session commend, then identifying the script comprises identifying a delete script;
if the termination signal is associated with a deactivation session commend, then identifying the script comprises identifying a deactivation script.

20. The one or more storage media of claim 16, wherein the instructions, when executed by the one or more computing devices, further cause, prior to receiving the input:
receiving reference data that identifies a storage location of the script;
in response to receiving the reference data, downloading, from the storage location, the script to storage that is local to the virtual machine.
